(19) United States
(12) Patent Application Publication
(10) Pub. No.: US 2024/0104533 A1
(43) Pub. Date: Mar. 28, 2024

(54) BANKING AT A SCREEN-LESS ATM USING A MOBILE DEVICE

(71) Applicant: Bank of America Corporation, Charlotte, NC (US)

(72) Inventors: Arjun Thimmareddy, Charlotte, NC (US); Bryan T. King, Charlotte, NC (US); Alexander S. Lee, Jacksonville, FL (US); Vaishnavi Varma, New York, NY (US); Tony Aidoo, Aubrey, TX (US); Paula M. Booze, Charlotte, NC (US); Ramesh B. Chandanala, Charlotte, NC (US); William R. Conrad, New Castle, DE (US); Juliet Abdul-Aziz, Chester (GB); Gerard P. Gay, Seattle, WA (US)

(21) Appl. No.: 17/950,252

(22) Filed: Sep. 22, 2022

(51) Int. Cl. G06Q 20/10; G06Q 20/32; G06Q 20/40; G07F 19/00

(52) U.S. Cl. CPC G06Q 20/1085; G06Q 20/3278; G06Q 20/409; G07F 19/20

(57) ABSTRACT

A screen-less automated teller machine (ATM) may be configured to interact with a mobile device. The ATM may automatically detect the presence of the mobile device in a vicinity of the ATM and initiate contact with the mobile device, or a mobile device may initiate contact with the ATM. After verifying user permission to access the ATM, the mobile device may be enabled to provide user access to one or more of the banking services available at the ATM using the mobile device. As the ATM is screen-less, banking-related information may be viewed and/or input at the ATM using the mobile device. An application on the mobile device may be used to access and interact with the ATM using the mobile device.

### FIELD OF THE DISCLOSURE

Aspects of the disclosure relate to a screen-less automated teller machine (ATM) or a point-of-sale device (POS) and the use of a mobile device to engage in banking functions on the screen-less ATM or POS.

### BACKGROUND OF THE DISCLOSURE

A user usually initiates a transaction at an ATM or POS using an electronic card, such as a bank card, debit card, or credit card. (Unless otherwise noted, the term ATM is used herein to also refer to a POS). The user is then prompted for a personal identification number (PIN) at the ATM. Upon the detection of a correct PIN number entry at the ATM, the ATM or POS may provide the user with access to banking services that may be performed at the ATM.

Prior art ATMs have a screen. A menu of available banking services may be displayed on the screen at the ATM and the user may select a desired option from the menu. Available banking services at an ATM may include withdrawals, transfers, balance inquiries, and may include deposits, to name a few. Available banking functions at a POS may include point of service electronic funds transfers. Some ATMs may have a touchscreen that allows a user to select a function from the menu of options and enter other information such as amounts to withdraw or an amount of a deposit directly on the screen. Some ATMs have a screen without touchscreen functionality. When the screen is not a touchscreen, a menu may be shown on the screen of the ATM and selections from the menu may be performed using one or more buttons provided on the sides of screen. A numeric or alphanumeric keypad may be provided for data entry such as to entry a personal identification number (PIN) to gain user access to the ATM or to enter an amount of money to withdraw, deposit, transfer or pay. Data may be input to the ATM by a user using one or more input devices, such as with a keypad, buttons adjacent the screen, or directly on a touchscreen.

In using an ATM in a conventional manner, some users may be wary that other people near the ATM may be able to see the screen on the ATM while they are engaged in transactions. Some users may forget to bring the card needed to use the ATM.

It is an object of this invention to make interactions with an ATM more secure and convenient.

### SUMMARY OF THE DISCLOSURE

Methods, an apparatus, and a mobile app may be provided to enable a banking transaction to be conducted at an ATM using a mobile device. The ATM may be screen-less such that the ATM has no screen for use in accessing banking services or performing a banking transaction. Instead, banking services at the ATM may be accessed and banking transaction performed using a mobile device. The screen on the mobile device may be used for viewing or inputting banking-related information. The ATM may have at least one of a deposit slot, a withdrawal tray, or a receipt dispenser.

In embodiments, the screen-less ATM and the mobile device may be configured to communicate via short range wireless communication, such as one or more of near-field communication (NFC), Zigbee, Wi-Fi, Bluetooth, or Ultra-Wideband technologies. In embodiments, the ATM and the mobile device may be configured to communicate using a mobile communications network.

The method may include automatically detecting, by the ATM, a presence of the mobile device of a user in a vicinity of the ATM. The presence may be detected using short range wireless communication. After automatically detecting the presence of the mobile device using short range wireless communication, the presence of the mobile device may be verified. In embodiments, the presence may be verified using a Global Positioning System (GPS) location obtained from the mobile device. The detection or verification of the mobile device may trigger a pushing, to the mobile device, of a mobile application to access banking services on the ATM using the mobile device.

In embodiments, a mobile device may request to initiate a banking transaction with the ATM without an automatic detection of a mobile device by the ATM. For example, a user may initiate the banking transaction with the ATM using the mobile device before the mobile device may be automatically detected.

The method may include transmitting, by the ATM, a signal to the mobile device to prompt the user to select an option on the mobile device to access banking services offered at the ATM using the mobile device. In some embodiments, the signal that is transmitted may include a message that includes a link for the mobile device to access a mobile application. The mobile application may provide an interface for the entry of user identification information and for access to the services offered at the ATM. In some embodiments, the transmission of the signal from the ATM to the mobile device may trigger the launch (opening) of a mobile application on the mobile device.

In some embodiments, the mobile application that may be launched may include a menu that replicates the menu that would have been accessed on an ATM had a screen been available on the ATM. In some embodiments, the mobile application may be different from the menu that would have been accessed on the ATM.

The method may further include verifying that the user has permission to access the banking services offered at the ATM based on user identification information entered at and submitted via the mobile device. In embodiments, the verification may include multi-factor authentication using two or more credentials. After verification of the user identification information, the user may be enabled to access one or more of the banking services at the ATM using the mobile device and to view account-related information on the mobile device.

In embodiments, when the user is banking using the mobile device, the method may enable the user to elect to make a deposit or a withdrawal at the ATM via a user selection on the mobile device. In embodiments, the ATM may accept the deposit or dispense the withdrawal elected by the user using the mobile device.

One or more images or video may be obtained with a camera on the mobile device to monitor security near the mobile device.

A method may also be provided for using a mobile device to conduct a banking transaction via an ATM that is screen-less using a mobile device. The method may provide a mobile device having a short-range wireless communication capability such that the mobile device is automatically detectable by an ATM in a vicinity of the ATM. The mobile device may engage in a short range wireless communication with the ATM upon detection of the mobile device by the ATM. The mobile device may be configured to permit entry, at the mobile device, of user identification information to access banking services provided at the ATM. After verification, the mobile device may verify, via the ATM, that the user has permission to access the banking services offered at the ATM based on the user identification information.

The method may include accessing of the one or more banking services at the ATM using a mobile application on the mobile device.

The method may include submitting, using the mobile device, a request for a deposit to be performed at the ATM, thereby causing the ATM to accept the deposit at the ATM. The method may include submitting, using the mobile device, a request for the ATM to dispense a withdrawal at the ATM, thereby causing the ATM to dispense the withdrawal at the ATM.

A method may also be provided for enabling a banking transaction to be conducted at an ATM that is screen-less using a mobile device for user interaction with the ATM. The method may provide access, by the ATM to a mobile device in a vicinity of an ATM, to enable a user to select an option to access banking services offered at the ATM using a mobile device. The method may verify that the user has permission to access the banking services offered at the ATM based on user identification information submitted via the mobile device. After verification of the user identification information, the method may enable the user to access the banking services at the ATM using the mobile device and to view information related to the banking services on the mobile device.

An ATM may be provided that includes a non-transitory computer-readable memory storing computer-executable instructions that, when executed by a processor on a computer, cause the computer to perform the steps of providing access, by an ATM to a mobile device in a vicinity of an ATM, to enable a user to select an option to access banking services offered at the ATM using a mobile device, verifying that the user has permission to access the banking services offered at the ATM based on user identification information submitted via the mobile device, and, after verification of the user identification information, enabling the user to access the banking services at the ATM using the mobile device and to view information related to the banking services on the mobile device. The ATM may be screen-less such that the ATM has no screen for accessing banking services or performing a banking transaction. The banking services that the user may be enabled to access at the ATM using the mobile device may include at least one of a cash withdrawal, a deposit of cash or a check, an electronic transfer, a check balance transaction or an electronic payment. The ATM may include at least one of a deposit slot, a withdrawal tray, or a receipt dispenser. The computer-executable instructions, when executed by a processor on a computer, may further cause the computer to perform at least one of accepting a deposit or dispensing a withdrawal at the ATM.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative ATM that is screen-less in accordance with principles of the disclosure.

FIG. 2 shows an illustrative manner of using one or more mobile devices to interact with an ATM that is screen-less in accordance with principles of the disclosure.

FIG. 3 shows an illustrative series of screens that may appear on a mobile device while interacting with the ATM in accordance with principles of the disclosure.

FIG. 4 shows an illustrative flow chart of method steps that may be performed at a screen-less ATM in accordance with principles of the invention.

FIG. 5 shows an illustrative flow chart of method steps that may be performed at a mobile device to interact with the screen-less ATM in accordance with principles of the invention.

FIG. 6 shows an illustrative system architecture in accordance with principles of the disclosure.

FIG. 7 shows an illustrative architecture of a mobile device in accordance with principles of the disclosure.

### DETAILED DESCRIPTION OF THE DISCLOSURE

The present disclosure relates to methods of interacting with an ATM that is screen-less using a mobile device for data input and display. The ATM may be used to obtain or submit items or objects. For example, the ATM may be used to obtain a cash withdrawal, to obtain a printed receipt or to deposit checks or cash.

Illustrative embodiments of methods and apparatus in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of methods and apparatus in accordance with the principles of the invention. The features are illustrated in the context of selected embodiments. It will be understood that features shown in connection with one of the embodiments may be practiced in accordance with the principles of the invention along with features shown in connection with another of the embodiments.

Methods and apparatus described herein are illustrative. Methods and apparatus of the invention may involve some or all of the steps of the illustrative methods and/or some or all of the features of the illustrative apparatus. The steps of the methods may be performed in an order other than the order shown or described herein. Some embodiments may omit steps shown or described in connection with the illustrative methods. Some embodiments may include steps that are not shown or described in connection with the illustrative methods, but rather are shown or described in a different portion of the specification.

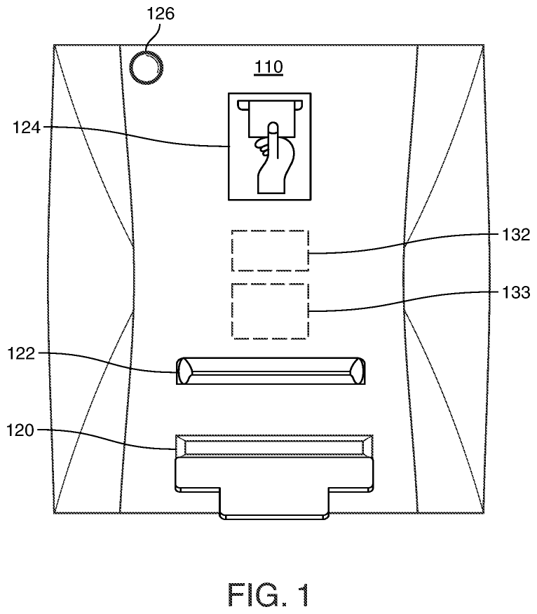

FIG. 1 shows an illustrative screen-less ATM 110 in accordance with principles of the disclosure. ATM 110 may be provided by a bank or a non-bank operator (e.g., an ATM installed at a store). ATM 110 may be configured by hardware, software, or a combination thereof, to provide a variety of services. Some ATMs may provide a fuller set of services including cash withdrawals, cash or check deposits, electronic transfers, check balances, electronic payments, or other banking functions. Some ATMs may provide a subset of these services or other services.

ATM 110 may be standalone, located in a kiosk 111, may be mounted in a wall, or otherwise made available to users. Components or circuitry coupled to ATM 110, such as any components or circuitry mounted in or near ATM kiosk 111 or otherwise connected or linked to ATM 110, may also be considered part of ATM 110 for purposes of this disclosure.

Notably, ATM 110 is screen-less. As described below, a screen on a mobile device is used instead to interact with ATM 110, such as for viewing and for input. Screen-less ATM 110 may include a tray 120 to dispense cash, a deposit slot 122 to deposit cash or checks, a receipt dispenser 124 to dispense receipts for transactions performed at the ATM, and a security camera 126 to monitor an area surrounding the ATM.

ATM 110 may include a transceiver 132 and/or router 133 configured for communicating with mobile devices. In embodiments, transceiver 132 and/or router 133 may communicate via one or more short range wireless communications technologies. For example, transceiver 132/router 133 may be compatible with one or more of near-field communication (NFC), Wi-Fi, Zigbee, Bluetooth, or Ultra-Wideband (UWB) technologies. Transceiver 132/router 133 may operate as a detector for detecting a presence of a mobile device in the vicinity of ATM. ATM 110 may be configured for communication with a mobile communications network.

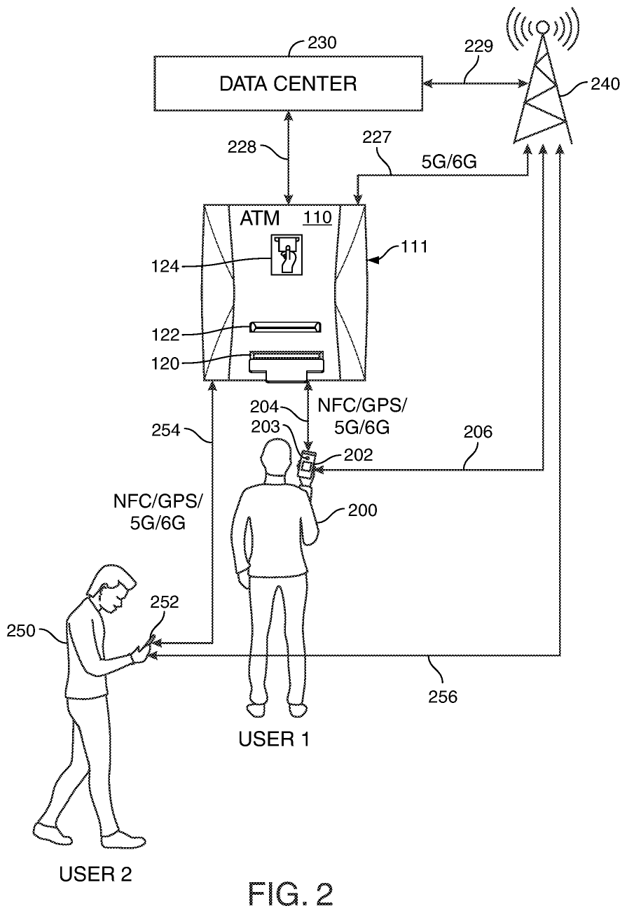

FIG. 2 shows an illustrative environment in which users may interact with an ATM 110 using a mobile device in accordance with the present disclosure. Only one ATM is shown in FIG. 2. However, there may be multiple ATMs at a particular location. While ATM 110 may be screen-less, there may be one or more other ATMs at that same location near ATM 110 that have their own screens for those who want to bank conventionally using an ATM that has a screen.

ATM 110 may be configured to communicate with a data center 230. Data center 230 may include one or more central servers. Communications between ATM 110 and data center 230 may be configured to be conducted via link 228, which may represent one or more wired connections. Communications between ATM 110 and data center 230 may be performed via a wireless communication network 240, such as via a 5G network, using a wireless link or links 227 and 229. Communications may also be conducted via a combination of wired and wireless communications.

Data center 230 may be maintained as a private network or may be cloud-based. Data center 230 may provide access to and store data, including financial data. The data may allow ATM 110 to verify a user's identity, to provide financial information needed by the ATM such as customer account information and balances available, and to collect information relating to new transactions performed at ATM 110.

Mobile device 202 may be one of a smartphone, a laptop, tablet, iPad, a smart car, a smart card, or any other computing device that is able to communicate with ATM 110 using one or more wireless communication technologies. The wireless communication technology that is used for mobile—ATM communications may include a short range wireless communication technology. Mobile device 202 may have a display and may have one or more ports to connect external devices. The display on mobile device 202 may be a touchscreen, in which case user input may be via the screen. Mobile device 202 may have or be connected to a keypad (not shown) for user input. Mobile device 202 may also have or be connected to one or more cameras, such as camera 203, on the front or back of mobile device 202. Mobile device 202 may communicate with ATM 110, for example, over link 204 such as with a short range wireless communication or via a link 206 over a mobile communications network 240, such as a 5G or 6G network.

Mobile device 202 may have a memory that is configured to have one or more applications (“mobile applications” or “apps”) saved thereon. One of the applications that may installed on the mobile device 202 may be an application to access services available at ATM 110.

As shown in FIG. 1, a first user 200, user 1, in the vicinity of ATM 110 may access ATM 110 with mobile device 202.

User 200 may initiate contact with ATM 110 using mobile device 202 even before user 200 is in proximity to the ATM 110 such that mobile device 202 may be detected by ATM 110. User 200 may already have the relevant application loaded on mobile device 202 or may have to download the application to the mobile device 202 to initiate contact.

In embodiments, user 200 need not initiate contact as ATM 110 may be configured to automatically detect the presence of mobile device 202 when mobile device 202 comes into proximity to ATM 110. The specific distance of mobile device 202 to ATM 110 that may trigger the detection of mobile device 202 may vary. For example, the distance may be based on a particular short-range wireless communication technology that may be used. For example, mobile device 202 detection may be detected within a range of 3 or fewer feet from ATM 110 using one type of technology or may have a longer range with a different technology.

ATM 110 may perform a check to confirm the presence of mobile device 202 at the expected location near ATM 110. The additional check may be performed by transmitting a signal to mobile device 202 to allow ATM 110 to verify the expected location using a Global Positioning System (GPS) information from mobile device 202, and to compare the verified location of mobile device 202 to the location of ATM 110. Any detected anomaly between the GPS location information and the expected location may be noted and may cause the transaction to be terminated or re-confirmed. This may help to prevent fraud or to account for a system malfunction. Confirmation of user information may be performed in conjunction with data center 230.

ATM 110 may transmit a signal to mobile device 202 to prompt user 200 to access services offered at the ATM using mobile device 202. The signal may be transmitted in one or more formats, such as via a notification sent to mobile device 202. In embodiments, the notification may be sent, for example, using a short range wireless technology, such as NFC, to alert user 200 of a banking option using mobile device 202. The notification may also push a link to the mobile application to mobile device 202. User 200 may use the link to download and install the mobile application if the user does not already have the application installed on mobile device 202.

If user 200 chooses to access services offered at ATM 110 on mobile device 202, user may login to ATM 110 using the mobile application. To login, ATM 110 may request that user identification information be entered on mobile device 202 to verify the user's identity and ensure that the user has permission to access the services offered at ATM 110. The user identification information that is required by ATM 110 for verification may vary. Verification may require entry on mobile device 202 of a user ID and a PIN number or other password. For more secure access, multi-factor authentication may be used. For example, in some embodiments, in addition to a user login, a security code may be sent to mobile device 202 and the security code must be entered correctly to confirm user identification. In some embodiments, a security/challenge question must be answered. In some embodiments, entry of biometric data on mobile device 202 may be required. Examples of biometric data that may be used include a fingerprint, a picture of the user's face for performing face recognition, or a voice print, to name a few. Verification by ATM 110 may be performed with reference to user information that is stored at data center 230. Upon successful verification, a banking session may begin.

User 200 may perform transactions via ATM 110 using mobile device 202. ATM 110 may confirm transactions (e.g., account balances or money available for withdrawal) by communicating with data center 230 where the information is maintained and updated. ATM 110 may be used to dispense cash for withdrawals and to deposit cash or checks where ATM 110 has those capabilities. ATM 110 may also be used to dispense a paper receipt at the close of the banking session.

FIG. 2 also shows that a second user 250, User 2, may be waiting to use ATM 110 for a future banking transaction using mobile device 252 of user 250 while user 200 is conducting a transaction using mobile device 202. Mobile device 252 may communicate with ATM 110, for example, over link 254 such as with a short range wireless communication (e.g., NFC) or via link 256 over a mobile communications network 240, such as a 5G or 6G network. Mobile device 252 may obtain and install the mobile application to interact with ATM 110 via the Internet while waiting for user 200 to complete the banking session of user 200. In some embodiments, if the range of wireless communications from ATM 110 is sufficient to reach mobile device 252 while user 202 is interacting with ATM 110, ATM 110 may push a notification to mobile device 252. The notification may provide access to or activate the mobile application on mobile device 252 to prepare for a banking session between ATM 110 and mobile device 252 after the current session with mobile device 202 is completed. User 250 may just wait to obtain the mobile application to be pushed from ATM 110 after the current session with user 200 is completed.

As another option, while waiting to access ATM 110, user 250 may use the mobile application to log in to a web site to initiate communication with ATM 110. When user 200 is finished with the session on ATM 110, mobile device 252 may transfer online communication to communicate directly with ATM 110 such as to perform withdrawals, deposits, or obtain a printed receipt.

The use of mobile device 202 also enables one or more cameras 203 on mobile device 202 to monitor the surroundings while user 200 is using ATM 110. The video may be provided as a live feed from mobile device 202 to a security monitoring system that may be implemented at ATM 110 and may be used to capture images or video to supplement video captured by camera 226 at ATM 110.

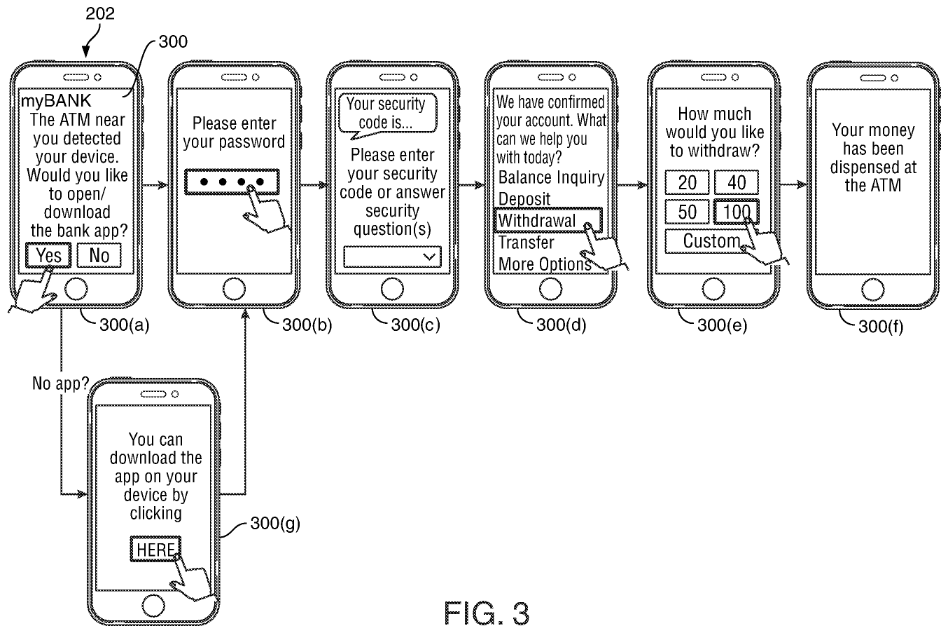

FIG. 3 shows an example of illustrative screens that may be displayed on a screen 200 of mobile device 202 during interactions between ATM 110 and mobile device 202.

Screen 300(a) shows an illustrative screen when ATM 110 detects mobile device 202. The screen may offer the option to open or download the mobile application. Upon selection of open/download, if the application is not already installed on mobile device 202, screen 300(g) may be displayed to offer an option of downloading the application.

The mobile application may be launched on mobile device 202 and may be displayed on the entirety of the screen or just on a portion of the screen.

Screen 300(b) shows an example of one of the screens that may be used in entering user identification information for user verification purposes during login. This may be followed by another screen, such as screen 300(c), that requests a verification code or an answer to one or more security/challenge questions for multi-factor authentication.

Once the user is granted access to ATM 110, a screen may appear on mobile device 202 showing a menu of available banking services (transactions) that may be performed using mobile device 202 via ATM 110. The menu that appears may replicate the menu screen that would have been accessed on an ATM that had a screen. The menu could also look different from an ATM menu screen. An illustrative screen is shown in screen 300(d). The desired service may then be selected. If not all services may be displayed on a single screen, the screen may offer a user an option to select “More Options” to see additional service options. In the example illustrated in screen 300(d), a user chooses to perform a withdrawal via ATM 110. Screen 300(e) may then present a screen to choose an amount to withdraw. Screen 300(f) may then indicate that money has been dispensed at ATM 110.

ATM 110 may also be located alongside a drive-thru lane for an occupant of the vehicle to access ATM 110 using a mobile device. Mobile device may be positioned within the vehicle. Mobile device in the vehicle may be a laptop, iPad, tablet, a smartphone, a computing system run on a smart car, or any other computing device. The computing system may be a vehicle-installed system that may include, for example, a screen mounted to a dashboard, a car roof, or back of a seat, that supports short range communication or wireless communication, such as (NFC), Wi-Fi, Zigbee, Bluetooth, or Ultra-Wideband (UWB) technologies and that is enabled to support an app that interacts with an ATM. Mobile application may be loaded on mobile device. When computing system is a vehicle-installed system, the mobile application may appear on a portion of the screen of the mobile device, rather than on an entirety of screen. This allows room for display of other information on the screen of the mobile device such as GPS information.

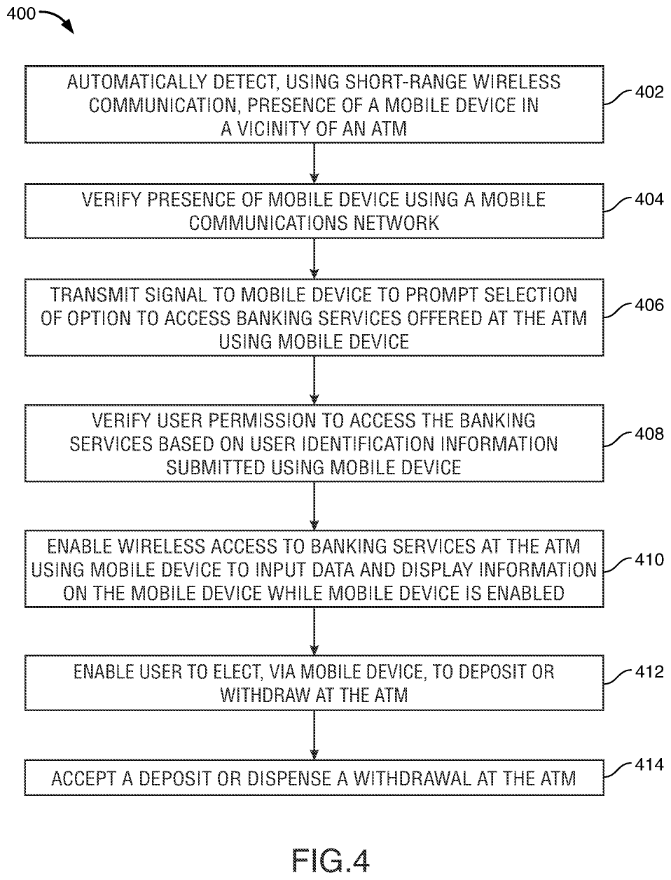

FIG. 4 shows an illustrative flow chart of a method 400 that may be performed at ATM 110 in accordance with principles of the invention.

The method 400 may begin at step 402 when an ATM may automatically detect the presence of a mobile device in a vicinity of the ATM. The detection may be via a short-range wireless communication. Step 402 may be unnecessary where the user of the mobile device initiates communication with the ATM before being detected. At step 404, the presence of a mobile device in the vicinity of the ATM may be verified, such as by using a mobile communications network. At step 406, the ATM may transmit a signal to the mobile device to prompt a user of the mobile device to select an option to access banking services offered at the ATM using the mobile device. At step 408, if a user requests access to banking services offered at the ATM, the ATM may verify the user permission to access the banking services that are requested based on user identification information submitted using the mobile device. At step 410, after verification of the user identification information, the ATM may enable wireless access to banking services at the ATM using the mobile device to input data and display information. At step 412, the ATM may enable a user to elect to make a deposit or withdrawal at the ATM. At step 414, the ATM may accept a user's request to make a deposit or dispense a withdrawal at the ATM. Multiple transactions may be made during a single banking session. When the transactions are completed, the user logs off and the session ends.

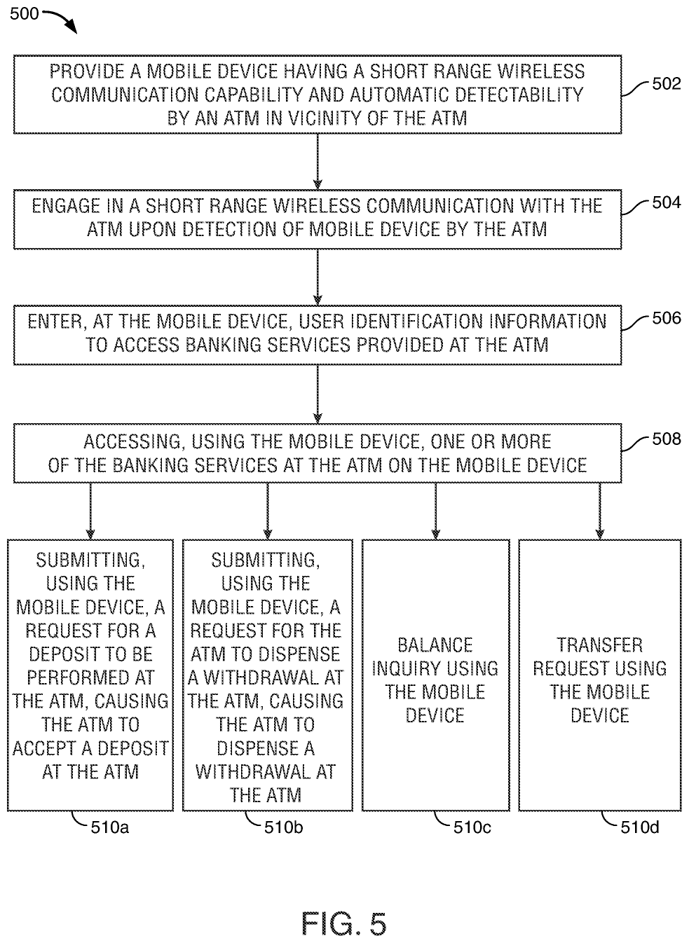

FIG. 5 shows an illustrative flow chart of a method 500 that may be performed at a mobile device in accordance with principles of the invention. At step 502, a mobile device may be provided. The mobile device may have a short range wireless communication capability and may be automatically detectable by an ATM when the mobile device is in the vicinity of the ATM. At step 504, the mobile device may engage in a short range wireless communication with the ATM upon detection of the mobile device by the ATM. At step 506, a user may enter at the mobile device user identification information to access banking services provided at the ATM. At step 508, if the user identification information is verified by the ATM, the user may access one or more of the banking services at the ATM using the mobile device. At step 510a, the user may, for example, submit a request, using the mobile device, to perform a deposit at the ATM. At step 510b, the user may, for example, submit a request, using the mobile device, for the ATM to dispense a withdrawal. At step 510c, the user may, for example, use the mobile device to request via the ATM a balance inquiry for one or more accounts. At step 510d, the user may, for example, use the mobile device to request that a funds transfer be performed via the ATM.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

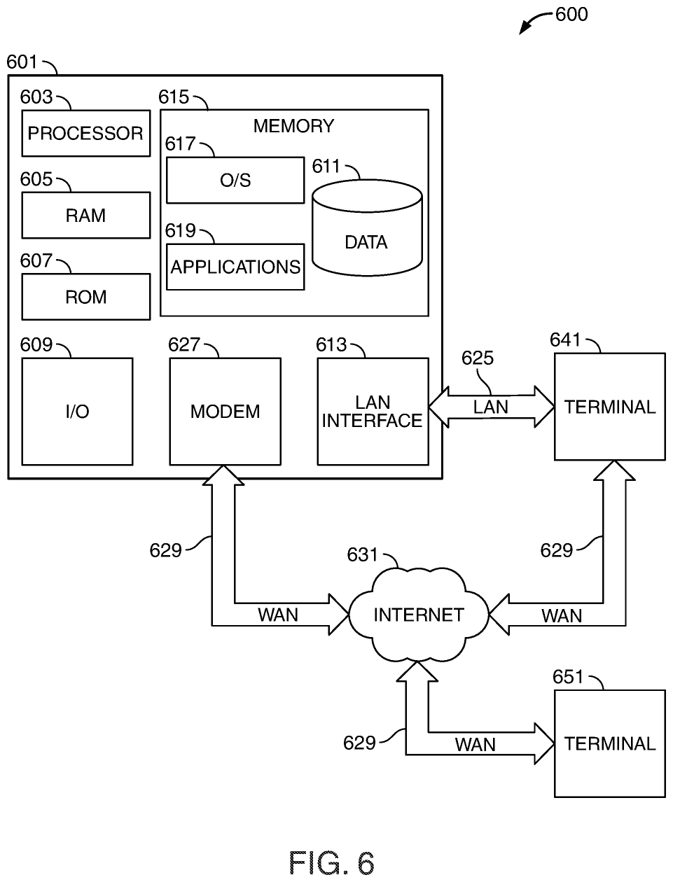

FIG. 6 shows an illustrative block diagram of system 600 that includes computer 801. Computer 601 may alternatively be referred to herein as an “engine,” “server” or a “computing device.” Computer 601 may be any computing device described herein, such as the computing devices running on the one or more of the ATM, smart phones, smart cars, smart cards and any other mobile device described herein. Elements of system 600, including computer 601, may be used to implement various aspects of the systems and methods disclosed herein.

Computer 601 may have a processor 603 for controlling the operation of the device and its associated components, and may include RAM 605, ROM 607, input/output circuit 609, and a non-transitory or non-volatile memory 615. Machine-readable memory may be configured to store information in machine-readable data structures. Other components commonly used for computers, such as EEPROM or Flash memory or any other suitable components, may also be part of the computer 601.

The memory 615 may be comprised of any suitable permanent storage technology—e.g., a hard drive. The memory 615 may store software including the operating system 617 and application(s) 619 along with any data 611 needed for the operation of computer 601. Memory 615 may also store videos, text, and/or audio assistance files. The data stored in Memory 615 may also be stored in cache memory, or any other suitable memory.

Input/output (“I/O”) module 609 may include connectivity to a microphone, keyboard, touch screen, mouse, and/or stylus through which input may be provided into computer 601. The input may include input relating to cursor movement. The input/output module may also include one or more speakers for providing audio output and a video display device for providing textual, audio, audiovisual, and/or graphical output. The input and output may be related to computer application functionality.

Computer 601 may be connected to other systems via a local area network (LAN) interface 613. Computer 601 may operate in a networked environment supporting connections to one or more remote computers, such as terminals 641 and 651. Terminals 641 and 651 may be personal computers or servers that include many or all of the elements described above relative to computer 601.

In some embodiments, computer 601 may be the ATM 110 and Terminals 641 and 651 may be the data center 230, and/or any of mobile devices 202, 252 that may be in electronic communication with ATM 110 via LAN, WAN or any other suitable short-range communication when a network connection may not be established.

When used in a LAN networking environment, computer 601 is connected to LAN 625 through a LAN interface 613 or an adapter. When used in a WAN networking environment, computer 601 may include a modem 627 or other means for establishing communications over WAN 629, such as Internet 631.

In some embodiments, computer 601 may be connected to one or more other systems via a short-range communication network (not shown). In these embodiments, computer 601 may communicate with one or more other terminals 641 and 651, such as the mobile devices including mobile devices 202, 252 described herein etc., using a personal area network (PAN) such as Bluetooth®, NFC, ZigBee, or any other suitable personal area network.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 619, which may be used by computer 601, may include computer executable instructions for invoking functionality related to communication, such as e-mail, Short Message Service (SMS), and voice input and speech recognition applications. Application program(s) 619 (which may be alternatively referred to herein as “plugins,” “applications,” or “apps”) may include computer executable instructions for invoking functionality related to performing various tasks. Application programs 619 may utilize one or more algorithms that process received executable instructions, perform power management routines or other suitable tasks.

Application program(s) 619 may include computer executable instructions (alternatively referred to as “programs”). The computer executable instructions may be embodied in hardware or firmware (not shown). The computer 601 may execute the instructions embodied by the application program(s) 619 to perform various functions.

Application program(s) 619 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 619 may include one or more algorithms that may be used to implement features of the disclosure.

The invention may be described in the context of computer-executable instructions, such as applications 619, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 601 and/or terminals 641 and 651 may also include various other components, such as a battery, speaker, and/or antennas (not shown). Components of computer system 601 may be linked by a system bus, wirelessly or by other suitable interconnections. Components of computer system 601 may be present on one or more circuit boards. In some embodiments, the components may be integrated into a single chip. The chip may be silicon-based.

Terminal 651 and/or terminal 641 may be portable devices such as a laptop, cell phone, Blackberry™, tablet, smartphone, or any other computing system for receiving, storing, transmitting and/or displaying relevant information. Terminal 651 and/or terminal 641 may be one or more user devices. Terminals 651 and 641 may be identical to computer 601 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smartphones, multiprocessor systems, microprocessor-based systems, cloud-based systems, programmable consumer electronics, network PCs, minicomputers, mainframe computers, distributed computing environments that include any of the above systems or devices, and the like.

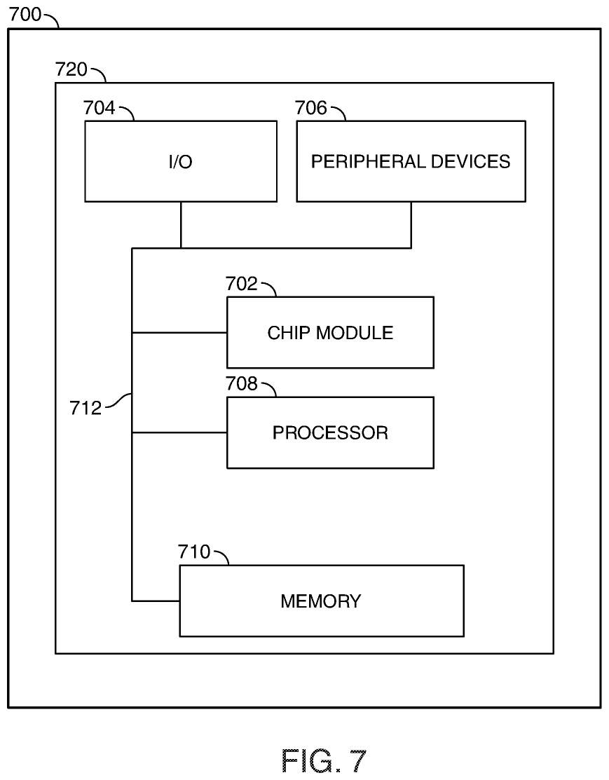

FIG. 7 shows illustrative apparatus 700 that may be configured in accordance with the principles of the disclosure. Apparatus 700 may be a computing device. Apparatus 700 may include chip module 702, which may include one or more integrated circuits, and which may include logic configured to perform any other suitable logical operations.

Apparatus 700 may include one or more of the following components: I/O circuitry 704, which may include a transmitter device and a receiver device and may interface with fiber optic cable, coaxial cable, telephone lines, wireless devices, PHY layer hardware, a keypad/display control device or any other suitable media or devices; peripheral devices 706, which may include counter timers, real-time timers, power-on reset generators or any other suitable peripheral devices; logical processing device 708, which may compute data structural information and structural parameters of the data; and machine-readable memory 710.

Machine-readable memory 710 may be configured to store in machine-readable data structures: machine executable instructions, (which may be alternatively referred to herein as “computer instructions” or “computer code”), applications such as applications 619, signals, and/or any other suitable information or data structures.

Components 702, 704, 706, 708 and 710 may be coupled together by a system bus or other interconnections 712 and may be present on one or more circuit boards such as circuit board 720. In some embodiments, the components may be integrated into a single chip. The chip may be silicon-based.

Some of the advantages of having a screen-less ATM may include:
(i) Makes possible a smaller form factor of the ATM;
(ii) May lower costs of manufacturing and operating ATM; and
(iii) Reduced energy costs for operating the ATM.

Some of the advantages of using a mobile device to interact with an ATM may be one or more of the following:
(1) security and privacy—persons other than an ATM user may not be able to see the screen on a mobile device, whereas they may be able to see the screen on an ATM;
(2) accessibility—easier access to an ATM for some who have difficulty accessing a screen on an ATM;
(3) versatility—e.g., the same mobile device may be used at different ATMs and certain aspects, such as some login credentials, may be saved for reuse;
(4) may avoid touching the buttons or screen on an ATM which is a concern to some customers;
(5) may avoid using card to initiate transaction;
(6) may reduce complexity of ATM operator updating software on the ATM.

Thus, methods and systems are provided for enabling an automated teller machine (“ATM”) to interact with a mobile device to access banking services and conduct banking transactions in the vicinity of the ATM using the mobile device. Persons skilled in the art will appreciate that the present invention can be practiced by other than the described embodiments, which are presented for purposes of illustration rather than of limitation.

What is claimed is:

1. A method for enabling a banking transaction to be conducted at an automated teller machine (ATM) that is screen-less using a mobile device for user interaction with the ATM, the method comprising:
automatically detecting, using short range wireless communication, a presence of a mobile device of a user in a vicinity of an ATM that is screen-less;
transmitting a signal to the mobile device to prompt the user to select an option to access banking services offered at the ATM using the mobile device;
verifying that the user has permission to access the banking services offered at the ATM based on user identification information submitted via the mobile device; and
after verification of the user identification information, enabling the user to access the banking services at the ATM using the mobile device and to view account-related information on the mobile device.

2. The method of claim 1, further comprising:
enabling the user to elect, via the mobile device, to perform a deposit or a withdrawal at the ATM.

3. The method of claim 2, further comprising:
accepting the deposit or dispensing the withdrawal at the ATM.

4. The method of claim 1, wherein the detecting of the mobile device using the short range wireless communication is performed via one or more of near-field communication (NFC) or Bluetooth.

5. The method of claim 1, further comprising:
verifying the presence of the mobile device using a mobile communications network, after automatically detecting the presence of the mobile device of a user in the vicinity of the ATM using the short range wireless communication.

6. The method of claim 1, wherein the presence of the mobile device in the vicinity of the ATM is verified using a Global Positioning System (GPS).

7. The method of claim 1, wherein the ATM and the mobile device communicate via one or more of the short range wireless communication or a mobile communications network.

8. The method of claim 1, wherein:
the step of transmitting the signal to the mobile device comprises transmitting a message that includes a link to access a mobile application;
wherein the mobile application provides an interface for entry of user identification information and for access to the banking services offered at the ATM.

9. The method of claim 1, wherein:
the step of transmitting the signal to the mobile device comprises triggering a launch of a mobile application on the mobile device;
wherein the mobile application provides an interface for entry of user identification information and for access to the banking services offered at the ATM.

10. The method of claim 1, wherein the detecting of the mobile device triggers a pushing of a mobile application to access banking services to the mobile device.

11. The method of claim 1, wherein the step of confirming that the user has permission to access banking services offered at the ATM comprises multi-factor authentication.

12. The method of claim 1, further comprising:
receiving a request from the mobile device to initiate a future banking transaction using the ATM before the presence of the mobile device is detected.

13. The method of claim 1, further comprising obtaining, from the mobile device, one or more images or video with a camera on the mobile device to monitor security near the mobile device.

14. A method of conducting a banking transaction via an automated teller machine (ATM) that is screen-less using a mobile device, the method comprising:
providing a mobile device having a short range wireless communication capability such that the mobile device is automatically detectable by an ATM that is screen-less in a vicinity of the ATM;
engaging, by the mobile device, in a short range wireless communication with the ATM upon detection of the mobile device by the ATM;
enabling entry, by a user at the mobile device, of user identification information to access banking services provided at the ATM; and
after verification, via the ATM, that the user has permission to access the banking services offered at the ATM based on the user identification information, enabling access, by the user using the mobile device, to the banking services at the ATM using the mobile device.

15. The method of claim 14, further comprising:
submitting, using the mobile device, a request for a deposit to be performed at the ATM, thereby causing the ATM to accept the deposit at the ATM.

16. The method of claim 14, further comprising:
submitting, using the mobile device, a request for the ATM to dispense a withdrawal at the ATM, thereby causing the ATM to dispense the withdrawal at the ATM.

17. The method of claim 14, wherein:
enabling access to the banking services at the ATM is performed using a mobile application on the mobile device.

18. The method of claim 14, wherein the short range wireless communication between the mobile device and the ATM is performed via one or more of near-field communication (NFC) or Bluetooth.

19. The method of claim 14, further comprising monitoring an environment near the mobile device using a camera on the mobile device, and providing one or more images or video obtained with the camera on the mobile device to monitor security near the ATM.

20. A method for enabling a banking transaction to be conducted at an automated teller machine (ATM) that is screen-less using a mobile device for user interaction with the ATM, the method comprising:
providing access, by an ATM that is screen-less to a mobile device in a vicinity of an ATM, to enable a user to select an option to access banking services offered at the ATM using a mobile device;
verifying that the user has permission to access the banking services offered at the ATM based on user identification information submitted via the mobile device; and
after verification of the user identification information, enabling the user to access the banking services at the ATM using the mobile device and to view information related to the banking services on the mobile device.

21. An automated teller machine (ATM) comprising:
a non-transitory computer-readable memory storing computer-executable instructions that, when executed by a processor on a computer, cause the computer to perform the following steps:
providing access, by the ATM to a mobile device in a vicinity of the ATM, to enable a user to select an option to access banking services offered at the ATM using a mobile device;
verifying that the user has permission to access the banking services offered at the ATM based on user identification information submitted via the mobile device; and
after verification of the user identification information, enabling the user to access the banking services at the ATM using the mobile device and to view information related to the banking services on the mobile device;
wherein the ATM is screen-less such that the ATM has no screen for use in accessing banking services or in performing a banking transaction.

22. The ATM of claim 21, wherein the banking services that the user is enabled to access at the ATM using the mobile device comprises at least one of:
a cash withdrawal;
a deposit of cash or a check;
an electronic transfer;
a check balance transaction; or
an electronic payment;

23. The ATM of claim 21, further comprising at least one of a deposit slot, a withdrawal tray, or a receipt dispenser.

24. The ATM of claim 21, wherein the computer-executable instructions, when executed by a processor on a computer, further cause the computer to perform at least one of the following steps:
accepting a deposit; or
dispensing a withdrawal at the ATM.
